(19) United States
(12) Patent Application Publication
(10) Pub. No.: US 2017/0221378 A1
(43) Pub. Date: Aug. 3, 2017

(54) COMMUNICATION MINING ANALYTICS SYSTEM

(71) Applicant: OMNITRACS, LLC, Dallas, TX (US)

(72) Inventors: Ramprasad RENGANATHAN, Duluth, GA (US); Lauren Domnick, Muskego, WI (US); Dean Croke, Acton, MA (US)

(21) Appl. No.: 15/011,239

(22) Filed: Jan. 29, 2016

(51) Int. Cl. G09B 19/00; G09B 5/00; B60Q 9/00

(52) U.S. Cl. CPC G09B 19/00; B60Q 9/00; G09B 5/00

(57) ABSTRACT

Aspects of the present disclosure generally related to one or more systems, methods, and devices for actively monitoring driver communications in order to identify at-risk drivers (e.g., drivers that may be susceptible to quitting). Additionally or alternatively, aspects of the present disclosure may determine whether the fleet operators are satisfactorily communicating and remedying driver behaviors that may lead to an adverse driver event.

### BACKGROUND

Nearly every good consumed by households and businesses, at some point, is transported on a truck. The vast majority of communities rely on trucks to routinely deliver all of their essential products necessary for basic existence. With the trucking industry being soundly intertwined with the country's economy, it is necessary for fleet operators to find, recruit, and retain qualified drivers for each truck on the road. Unfortunately, driver turnover and retention problems have been such a dilemma that the condition has become an accepted obstacle and is considered a natural cost of business.

Fleet operators have attempted to curb the driver turnover problem by increasing compensation for their drivers. However, in many instances, work satisfaction for drivers may not necessarily be driven by pay alone, but instead may include a combination of factors (e.g., benefits, work-life balance, professional development opportunities, etc.) that may be unique to each driver. Moreover, factors that may be important to each driver may dynamically vary over time based on changing circumstances. For example, while work-life balance may not be as important to a driver initially, the driver's desire to be home more often may increase after long stretches of being on the road. Conventional systems of identifying what may or may not be important to a driver are generally limited to periodic surveys that may be conducted for company-wide improvements that may not be flexibly adapted for each individual driver. Furthermore, such systems may be ill equipped to handle real-time changes to circumstances that may affect an individual driver's perception of work satisfaction.

Additionally, in recent decades, significant attention has been called to the issue of safety among truck drivers. In particular, the fact that many drivers may drive for long hours, and thus may be at a lowered sense of alertness, has contributed to a number of highway accidents and fatalities. As a result, systems for tracking, managing and maintaining a fleet of portable assets have been developed that may assist a fleet operator and/or truck driver in analyzing electronic information associated with driving activities and identify a likelihood of an adverse driver event occurring (e.g., a preventable accident, a severe accident, a traffic rule violation, an hours-of-service violation, etc.). However, such warning systems may be ineffective if the risk factors are not adequately communicated to the driver.

### SUMMARY

Aspects of the present disclosure generally related to one or more systems, methods, and devices for actively monitoring driver communications in order to identify at-risk drivers (e.g., drivers that may be susceptible to quitting). Additionally or alternatively, aspects of the present disclosure may determine whether the fleet operators are satisfactorily communicating and remedying driver behaviors that may lead to an adverse driver event.

Particularly, aspects of the present disclosure monitor communications (e.g., text or voice), for example, between the truck driver and a fleet operator established via a wireless communication device (e.g., mobile computing platform (MCP)) located in a cab and/or trailer of a vehicle and a terminal device located at a remote network center. Based on the monitoring of the communication, an analytics system may be configured to detect one or more key terms detected during the communication. In some aspects, the frequency of the key terms detected during the communication (or aggregated communications) may allow the analytics system to determine whether the driver is, for example, considering quitting and/or highlight factors that the driver may consider important in work satisfaction. For example, during a period of monitored communication, if the frequency of terms “home” or “family” appear in greater instances than the average of all other drivers, the analytics system may be able to deduce that the driver may be home sick.

Additionally or alternatively, if, during a period of monitored communication, the frequency of terms (e.g., home, family, etc.) appears in greater instances than the average baseline for that driver, in such instance, the analytics system may also deduce that the driver may be home sick. For example, if a driver's average baseline for terms such as “home” or “family” is twice per week (as calculated by observation over extended period of time (e.g., 10 weeks)) and for the period of monitored communication (e.g., 1 week) the analytics system detects greater instance of such terms (e.g., 15 times), the analytics system may issue an alert associated with the driver. Therefore, aspects of the present disclosure correlate the frequency of terms against not only other drivers, but may also compare against the driver's own baseline average. As a result, aspects of the present disclosure may generate an alert to the fleet operator with recommended remedial measures to initiate (e.g., adjust the driver's schedule or trip that would allow the driver to spend more time at home).

In other aspects, if, for a driver, an advanced warning system (disclosed in co-pending U.S. patent application Ser. No. 14/799,429 and incorporated herein by reference) indicates an elevated risk of an adverse driver event (e.g., a preventable accident, a severe accident, a traffic rule violation, an hours-of-service violation, etc.,) based on driving tendencies, aspects of the present disclosure may be configured to monitor communications between the truck driver and the fleet operator to calculate a quality of conversation value. In some aspects, the quality of conversation value may be used to identify or rate the effectiveness of the fleet operator's communication and remedial measures that may prevent the occurrence of the adverse driver event. For example, in some aspects, the advanced warning system may indicate that a driver is at an elevated risk of an adverse driver event because the driver tends to drive at night and has above average number of lane departures. Thus, in accordance with aspects of the present disclosure, the analytics systems may monitor the communication between the truck driver and the fleet operator (e.g., via MCP and terminal device) in order to evaluate whether the fleet operator has effectively communicated the risk to the driver.

Aspects of the present disclosure include a method, apparatus, and computer readable medium for wireless communication. In some examples, the method, apparatus, and computer readable medium may include monitoring, at a network device, communication between a first device and a second device. The first device may be associated with a driver and a second device may be associated with a fleet operator. Additionally or alternatively, in some aspects, the method, apparatus, and computer readable medium may include identifying one or more key terms detected during the communication and determining a number of instances that the one or more key terms are used in the communication during a time period. Additionally or alternatively, the method, apparatus, and computer readable medium may include calculating a driver score value based in part on the determining.

To the accomplishment of the foregoing and related ends, the one or more aspects of the present disclosure comprise the features hereinafter fully described and particularly pointed out in the claims. The following description and the annexed drawings set forth in detail certain illustrative features of the one or more aspects of the present disclosure. These features are indicative, however, of but a few of the various ways in which the principles of various aspects of the present disclosure may be employed, and this description is intended to include all such aspects and their equivalents.

### BRIEF DESCRIPTION OF THE DRAWINGS

The disclosed aspects of the present disclosure will hereinafter be described in conjunction with the appended drawings, provided to illustrate and not to limit the disclosed aspects, wherein like designations denote like elements, where a dashed line may indicate an optional element or action, and in which:

FIG. 1 illustrates a wireless communication system implementing various aspects of the present disclosure;

FIG. 2 is a functional block diagram of example elements of an aspect of a system including communication mining analytics component in accordance with various aspects of the present disclosure;

FIG. 3 is a functional block diagram illustrating the calculations for conversation quality score value(s) and ranking the plurality of drivers in accordance with various aspects of the present disclosure;

FIG. 4 is a flowchart of an aspect of a method in accordance with the present disclosure;

FIG. 5 is a block diagram of an example of an aspect of a mobile computing platform (MCP) in accordance with the present disclosure; and

FIG. 6 is a block diagram of an example of an aspect of a network management center (NMC) in accordance with the present disclosure.

### DETAILED DESCRIPTION

Various aspects will now be described with reference to the drawings. In the following description, for purposes of explanation, numerous specific details are set forth in order to provide a thorough understanding of one or more aspects. It should be understood, however, that such aspect(s) may be practiced without these specific details.

As discussed above, it may be difficult for fleet operators to efficiently gauge the impact a conversation may have with a driver as it relates to, but not limited to, aspects such as accident prevention or work retention. For example, if an advanced warning system identifies a driving pattern that may increase the risk of an occurrence of an adverse event (i.e., “accident predicted value” that quantifies the likelihood of a preventable accident) and the fleet operator communicates such risk to the driver, existing systems may be unable to determine the effectiveness (or ineffectiveness) of the communication. Additionally or alternatively, because the fleet operators (or managers) may communicate with any number of drivers on a daily basis, it may be difficult to track or quantify work factors (e.g., schedule, routes, etc.) that may be important to each driver individually.

Aspects of the present disclosure provide an analytics system that monitors and identifies drivers that may be at risk of an adverse event (e.g., terminating employment or being involved in a preventable accident). Additionally or alternatively, features of the present disclosure may evaluate the quality of the conversation between the fleet operator and the driver based on the monitoring of the communication to determine whether the fleet operator is taking adequate steps to remedy the probability of the adverse event. It should be noted that the terms “fleet operator” and “manager” may be used interchangeably in the specification to refer to one or more individuals that communicate with the truck driver.

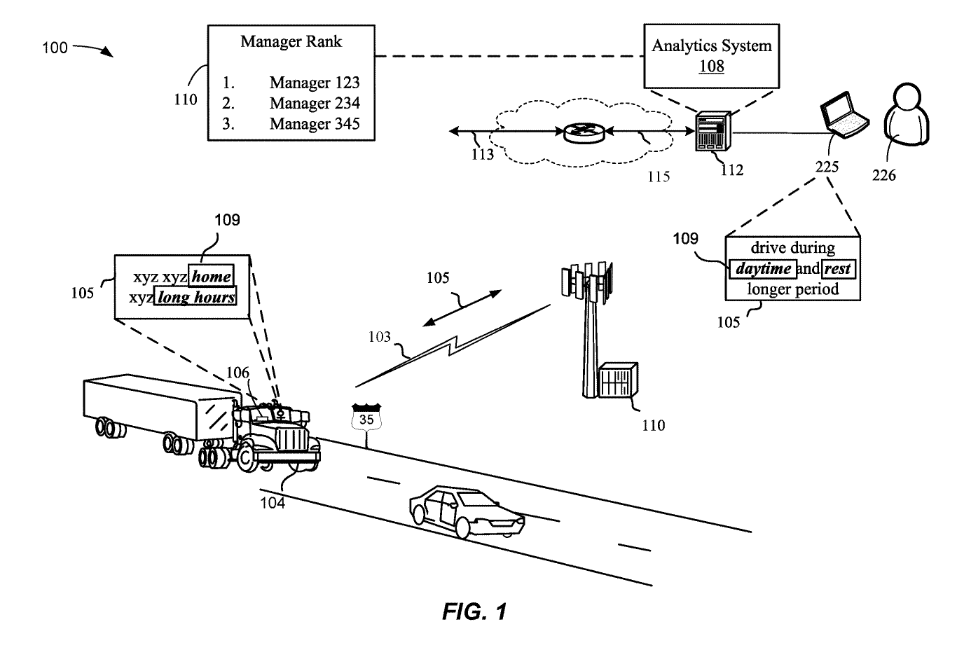

FIG. 1 illustrates one example of a wireless communication system 100 for implementing a communication mining capability in accordance with various aspects of the present disclosure. In some examples, the wireless communication system 100 may include one or more fleet vehicles 104 (e.g., truck, car, sports utility vehicle, etc.) in communication with a network device 112 via a base station 110, although other terrestrial or satellite-based communication technologies may be utilized. Specifically, the network device (e.g., network management center (NMC)) 112 may be configured to communicate with one or more vehicles 104 via an MCP 106 located on each vehicle 104 or associated with each driver of each vehicle 104. An example of an MCP 106 includes, but is not limited to, an MCP 50, an MCP 100, an MCP 110, an MCP 200, and a TT210 sold by OMNITRACS, LLC of Dallas, Tex. Accordingly, the MCP 106 and the network device 112 may exchange communication data 105 via a wireless communication link 103 and backhaul link 113 by utilizing one or more base stations 110, access points (APs) (not shown), and/or satellite communication (not shown). The network device 112 may provide user authentication, access authorization, tracking, internet protocol (IP) connectivity, advanced warning, and other access, routing, or mobility functions.

In some aspects, the network device 112 may actively monitor and receive one or more parameters from an MCP associated with a vehicle 104. The network device 112 may be in communication with a terminal device 225 that can be a user interface portal. In some aspects, a user 226 (e.g., fleet operator) may communicate with the truck driver via the terminal device 225 and the MCP (not shown).

In accordance with various aspects of the present disclosure, an analytics system 108, implemented at the network device 112, may monitor the communication data 105 between the terminal device 225 and the MCP 106 associated with the vehicle 104 during a time period (e.g., day, week, or month). During the predetermined time period, the analytics system may collect communication data 105 (e.g., text or voice communication data) associated with the communication between the terminal device 225 and the MCP. Based on the collected communication data 105, the analytics system of the present disclosure may identify and extract one or more key terms 109 (e.g., bolded key terms in communication data 105) of the communication data 105 detected during the communication. In some aspects, the identification of the one or more key terms 109 may be determined based on correlating a subset of the communication data 105 against one or more known key terms included in a database. Accordingly, based on the identification of the one or more key terms 109 (e.g., which may be the terms used in the communication data 105, and/or which may be terms derived from one of more terms used in the communication data 105), the analytics system 108 of the present disclosure may be configured to determine a manager score value for each manager in the fleet, and, optionally, rank each manager 110 based on the manager score value as is explained in further detail below.

In some examples, the manager score value may include calculating a conversation quality score value that represents a quality of conversation between the terminal device 225 and the MCP 106 measured. In some aspects, the term “conversation quality score value” may refer to a value (e.g., 1-100) that measures the effectiveness (or ineffectiveness) of the conversation between fleet operator and the truck driver in correcting a driving behavior or accurately identifying important work factors for each driver. The analytics system 108 may achieve the above calculations based in part on, for example, calculating a difference between accidents predicted value (likelihood of a preventable accident occurring prior to communication) and actual accident score (obtained from accident reports filed with the fleet) for each driver under each manager. Thus, in some examples, if the actual accident score (number of accidents following the conversation) is less than the accident predicted value (number of accidents originally predicted), the analytics system 108 may be able to maintain conversation quality score value of the effectiveness of any communication(s) that may have occurred between the truck driver and the fleet operator. Accordingly, based on such measurements, the analytics system 108 may be configured to rank the one or more managers according to how well each manager is reducing the risk of preventable accidents for drivers under his or her control.

Additionally or alternatively, calculating a conversation quality score may include identifying the difference between the retention prediction value (likelihood one or more drivers may quit) and the actual retention value (number of drivers that actually quit). Thus, in some examples, if the actual retention value is less than the retention prediction value, the analytics system may be able to maintain measurable parameters of the effectiveness of any communication(s) that may have occurred between the truck driver and the fleet operator following identification of risk factors. Conversely, if the actual retention value is greater than the retention prediction value, the analytics system may provide measurement statistics of the ineffectiveness of the conversation. Accordingly, based on such measurements, the analytics system 108 may be configured to rank the one or more managers according to how well each manager is improving retention of the fleet for drivers by taking necessary remedial measures.

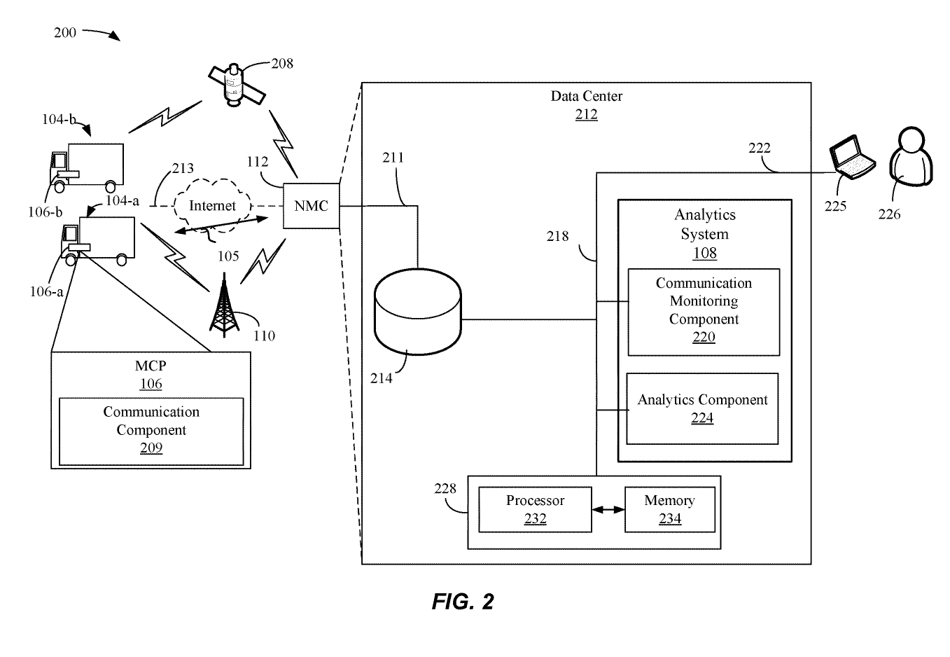

Referring now to FIG. 2, in an aspect, a system 200 (e.g., a more detailed view of system 100 of FIG. 1) includes components for implementing communication mining compatibility as illustrated in FIG. 1 above. As used herein, the term “component” may be one of the parts that make up a device, may be hardware (e.g., a processor) or software (e.g., computer executable instructions or code stored on a computer-readable medium) or firmware (e.g., a combination of both), and may be divided into other components and/or distributed across one or more processors.

In an aspect, system 200 can comprise a network management center (NMC) 112 configured to communicate with one or more vehicles 104 via a mobile computing platform (MCP) 106 located on each vehicle 104 or associated with each driver of each vehicle 104. The system 200 may include one or more fleets of vehicles 104, each fleet having at least one vehicle. Typically, a fleet could include as many tens, hundreds or thousands of vehicles. An example fleet 204 is illustrated as having two vehicles 104. Additional fleets (not shown) are contemplated, but not shown. In implementations, each MCP 106 is configured to collect and transmit data associated with the operation of the vehicle 104 to the NMC 112. In some aspects, the MCP 106 may include a communication component 209 configured to establish communication (e.g., text or voice) with the terminal device 225.

In some implementations, MCP 106 may include a processor configured to execute one or more aspects of the communication component 209 with external devices such as NMC 112 and/or terminal device 225 via a communication network. The MCP 106 may also include a memory configured to store computer-readable code that may define all or part of the components 207 and also to store data associated with the components and/or MCP 106. As such, in an aspect, processor and memory of MCP 106 may be specially programmed to perform the functionality described herein. MCP 106 may also include a user interface or display, a mobile application server, and a communications component 209 (e.g., including the one or more transceivers, and one or more of terrestrial and Wi-Fi modems, one or more antennae, a GPS component, and a satellite communications component).

As an example only, each vehicle 104 may be in bi-directional communication with NMC 112 over at least one communication channel. In the example shown in FIG. 2, each vehicle 104 is in bi-directional communication with the NMC 112 over at least one of a satellite-based communication system 208 or a terrestrial-based system 110 (e.g., a wireless communication system using a communication protocol/technology such as, but not limited to, GSM, CDMA, TDMA, WCDMA, EDGE, OFDM, GPRS, EV-DO, LTE, WiFi, Bluetooth, or, when the vehicle is stopped, via a wired connection 213 through the Internet). Depending on many factors, data may be exchanged with the vehicles 104 using one or both of the satellite communication system 208 and the terrestrial-based communication system 110.

In an aspect, many different types of data are collected and transferred from the vehicles 104 to the NMC 112. Examples of such data include, but are not limited to, vehicle performance data, driver performance data, critical events, messaging and position data, location delivery data, and many other types of data. All of the information that is communicated to and from the vehicles 104 may be processed via the NMC 112. The NMC 112 can be thought of as a data clearinghouse that receives all data that is transmitted to and received from the vehicles 104. Moreover, in an aspect, NMC 112 may include one or more back-end servers. Thus, in some aspects, the collected information (e.g., communication data) may periodically (e.g., every x minutes, where x is a real number, or once a day, or upon availability of a wired or wireless connection) be transmitted from the MCP 106 to the NMC 112 for analysis and record keeping.

The system 200 also includes a data center 212, which may be part of or in communication with NMC 112. The data center 212 illustrates one possible implementation of a central repository for all of the data received from each of the vehicles 104. As an example, as mentioned above many different types of data are transmitted from the vehicles 104 to the NMC 112. In the case where data center 212 is in communication with NMC 112, the data may be transmitted via connection 211 to the data center 212. The connection 211 may comprise any wired or wireless dedicated connection, a broadband connection, or any other communication channel configured to transport the data. Moreover, in an aspect, data center 212 may include one or more back-end servers analyzing the one or more parameters transmitted from the one or more MCP(s) 106. Additionally or alternatively, data may also be exchanged between the plurality of MCP(s) 106 using, for example, peer-to-peer (P2P) communication without the involvement of the NMC 112. In some aspect, the communication monitoring component 220 and/or analytics component 224 may further be in communication with a terminal device 225 that can be a user interface portal, a web-based interface, a personal computer (PC), a laptop, a personal data assistant (PDA), a smart phone, a dedicated terminal, a dumb terminal, or any other device over which a user 226, such as a manager or operator responsible for monitoring a fleet of vehicles 104, can view the display or receive a printed report provided by communication monitoring component 220 and/or analytics component 224.

In an aspect, the data center 212 may include a data warehouse 214 for receiving the data from vehicles 104 relating to vehicle and/or driver performance (e.g., driver biometric data). In an aspect, for example, data center 212 may include any number of application servers and data stores, where each may be associated with a separate fleet and/or driver management or performance data. In an aspect, each application server and data store may include a processor, memory including volatile and non-volatile memory, specially-programmed operational software, a communication bus, an input/output mechanism, and other operational systems. Each application server may relate to one or more service platforms, such as but not limited to one or more Analytics platforms, one or more Enterprise Services platforms, one or more ROADNET Anywhere platforms, one or more ROADNET Transportation Suite platforms, one or more Sylectus Network platforms, and/or one or more XRS platforms offered by OMNITRACS, LLC of Dallas, Tex. For example, an application server may be a services portal (SP) server that receives, for example, messaging and positioning (M/P) data from each of the vehicles 104. Another application server, for example only, may include one or more servers related to safety and compliance, such as a quick deployment center (QDC) server that receives, for example, critical event (CE) data from each of the vehicles 104. Further, for example, another application server may be vehicle and driver performance data related to fuel usage and/or cost from each of the vehicles 104. Additionally, for example only, another application server may relate to asset management, such as a Vehicle Maintenance and Vehicle Inspection Report server that receives, for example, maintenance and/or inspection data from each of the vehicles 104. It should be understood that the above list of example servers is for illustrative purposes only, and data center 212 may include additional and/or different application servers.

In one aspect, the data center 212 may include a communication monitoring component 220 for monitoring communication data 105 in communications between the terminal device 225 and the MCP 106. The communication monitoring component 220 may further be configured to identify one or more key terms 109 detected during the communication, and determine a number of instances that the one or more key terms 109 are used in the communication during a time period. In some aspects, the communication monitoring component 220 may further determine whether the number of instances that the one or more key terms are used in the communication is greater or less than fleet average (e.g., accumulation of a plurality of drivers in the fleet). If the number of instances that the one or more key terms are used in the communication is greater than the fleet average, the communication monitoring component 220 may assign greater weight value to the one or more key terms. Conversely, if the number of instances that the one or more key terms are used in the communication is less than the fleet average, the communication monitoring component 220 may assign a lower weight value to the one or more key terms. Additionally or alternatively, if, during a period of monitored communication, the frequency of terms (e.g., home, family, etc.) appears in greater instances than the average baseline for that driver, in such instance, the analytics system may also deduce that the driver may be home sick. For example, if a driver's average baseline for terms such as “home” or “family” is twice per week (as calculated by observation over extended period of time (e.g., 10 weeks)) and for the period of monitored communication (e.g., 1 week) the analytics system detects greater instance of such terms (e.g., 15 times), the analytics system may issue an alert associated with the driver. Therefore, aspects of the present disclosure correlate the frequency of terms against not only other drivers, but may also compare against the driver's own baseline average. As a result, the communication monitoring component 220 may be able to identify work factors (e.g., schedule, routes, etc.) that may be important to the one or more truck drivers on an individual basis.

Additionally or alternatively, the data center 212 may also include an analytics component 224 for calculating a driver score value and/or manager score value based in part on the determining. In some aspects, the analytics component 224 may be used to calculate the conversation quality score value and/or rank the manager based on a combination of factors identified above. For example, the analytics component 224, based on data received from the communication monitoring component 220, may determine how long (e.g., length of time) that the communication between the terminal device 225 and the MCP 106 lasted and the topics of discussion (based on key terms detected) during the communication. As such, the analytics component 224 may be configured to calculate/adjust the conversation quality score value to reflect the effectiveness of the fleet operator 226 to communicate with the truck drivers regarding correctable behaviors.

In an aspect, communication monitoring component 220 and/or analytics component 224 may be an analysis engine defined by or operating via a processing system 228, for example, connected via a system bus. In an aspect, the processing system 228 includes a processor 232 and a memory 234. In an example implementation, the functionality of communication monitoring component 220 and/or analytics component 224 as described herein may be implemented in one or more hardware or firmware processor components of processor 232. For instance, although illustrated as being separate components, communication monitoring component 220 and analytics component 224 may be a part of or in communication with processor 232. In another example implementation, the memory 234 can store the routines or functionality, e.g., in the form of computer-readable code or instructions, and/or the corresponding data, that are associated with communication monitoring component 220 and/or manager analytics component 224. In an aspect, the processor 232 can execute the stored routines (e.g., code) to implement the functionality of communication monitoring component 220 and analytics component 224 that are described herein. Although shown as residing within the data center 212, the processing system 228 may reside elsewhere, and may be implemented as a distributed system in which the processor 232 and the memory 234 may include one or more processor and memories, and may be located in different places, such as at NMC 112 and/or one or more servers associated with NMC 112 or data center 212.

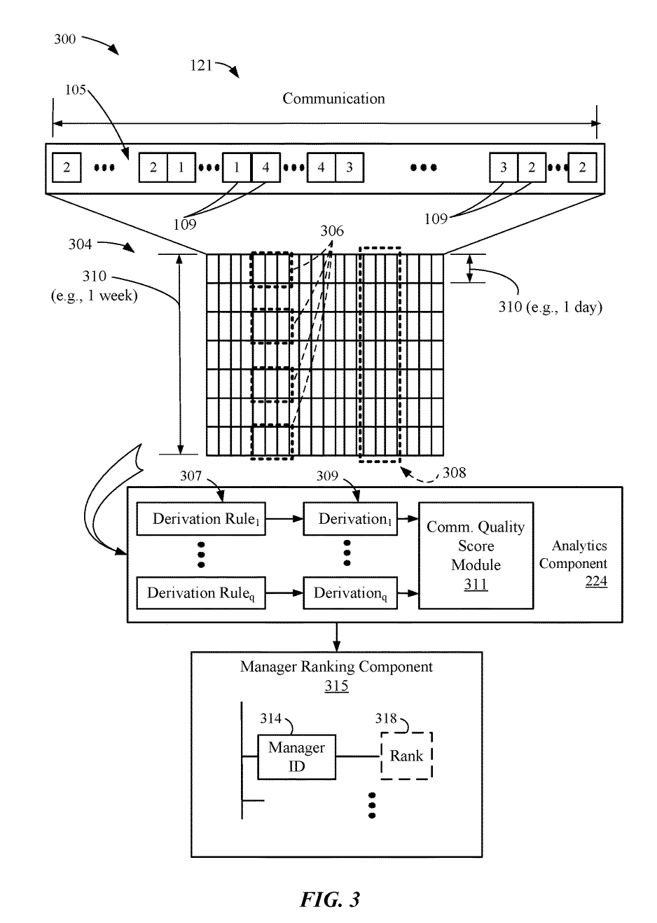

FIG. 3 illustrates one example 300 of the operation of analytics system 108 in monitoring communication between the terminal device (e.g., first device) and the MCP (e.g., second device) and computing the driver score value and/or the manager score value based on the monitoring, according to the present aspects. In some examples, the communication monitoring component 220 may monitor the communication 121 between the terminal device and the MCP to identify one or more key terms 109 detected in the communication data 105 during the communication 121. In some aspects, the communication 121 may be a single conversation or a series of conversations.

As mentioned above, the NMC 112 may include or be associated with data center 112. The data center 112, in some examples, may include communication monitoring component 220 and analytics component 224 for achieving one or more aspects of the present disclosure. It should be noted that this example implementation should not be construed as limiting, as one of skill in the art may modify this implementation and achieve similar results. For instance, rather than the illustrated actions of method occurring at NMC 112, the functionality associated with communication monitoring component 220, manager analytics component 224, and manager ranking component 315 may instead be implemented directly on MCP 106, which may then directly output manager score value and/or manager rankings.

In some aspects, one or more derivation rules 407 may be applied to the communication data 121 in order to identify the one or more key terms 109 in communication data 105 of the communication 121 during a predetermined time period. In some aspects, the analytics component 224 may include a function or equation to be applied to one or more portions of a set 304 of the communication data 105 collected for a predetermined time period 310 in order to define the one or more derivations 309. The set 304 may include collected one or more key terms 109 over a first predetermined time period (e.g., a week), while the derivation rules 307 may apply to one or more different time periods or subsets within set 304, including to one or more individual subsets 306 corresponding to selected time periods in set 304, as well as to one or more different aggregated subsets 308 of set 304. For instance, the one or more individual subsets 306 may include, as illustrated but not limited thereto, a subset of key terms 109 from a same time period during one or more different days of a week), and the one or more aggregated subsets 308 may include an aggregation such as a summation of the key terms over a time period.

Additionally, the function applied as part of each derivation rule 307 may be an identity function, e.g., where the value of key terms 109 is recorded, or the function may be any mathematical function, such as an average, mean, sum, standard deviation, comparison or difference, etc. In a simple example of a representative derivation rule 309, a representative derivation 309 may be defined as a sum of the aggregated subset 308. In another example, the one or more derivation rules 307 may define one or more derivations 309 such as a mean or standard deviation of the aggregated subset 308 of a number of iterations of the one or more key terms detected in the communication 121 during a predetermine time period 310. Other more complicated derivation rules 307 may quantify the occurrence of certain derivations 309 that can be defined by the set 304 in certain time periods, or certain combinations of derivations 309 that can be defined in certain time periods, or the absence of certain derivations 309 in a certain time period, or any combination thereof.

In an aspect where analytics component 224 is to compute a driver score value and/or conversation quality score value for each communication 121, the analytics component 224 may sum one or more of: Ego Metric Score, Interactant Score, Hours to Remediation (HoR) score, Time between Remediations (TBR) score, word count score, login score, conversation score, and work load score. In some aspects, the ego metric score may be computed based on identification of number of times that term such as “I,” “my,” or “me” occur in the conversation. As a non limiting example, if the number of times the key words “I,” “my,” or “me” are detected during a conversation is less than 1, the analytics system may assign an ego metric score of zero (0). However, if the number of times the key words “I,” “my,” or “me” are detected during a conversation is greater than 2 but less than 3, the ego metric score may equate to −0.5, for example. It should be understood by those of ordinary skill in the art that any range and value may be assigned for the calculation of the ego metric score.

In other aspects, interactant score may be based on the number of times the words such as “my,” “mine,” “I,” “me,” “ours,” “we,” “us,” “your,” “you,” “her,” “she” etc. occur during the predetermined time period of the communication 121. Additionally or alternatively, HoR score may be based on the number of hours to remediation for the communication. Furthermore, TBR score may be a value that indicates an amount of time that a fleet operator (or manager) is spending between each conversation. For example, if a fleet operator spends an hour between speaking with a first driver and the second driver, the TBR score may reflect accumulation of time (e.g., one hour) that the fleet operator spent between conducting each conversation. In some aspects, the word count score may be represented by taking a sum of all word counts in the conversation over the total number of communications between the first MCP and the terminal device (e.g., where there are multiple separate communications 121 between the truck driver and the fleet operator). The “login count” may reference the number of times that the fleet operator/manager may log into web portal to input reports associated with the conversation. Additionally or alternatively, the conversation count may be a total number of communication(s) 121 that the terminal device initiates with the MCP. In other aspects, the driver count may be number of drivers that the fleet operator speaks to during a predetermined time period. For example, if, based on advanced warning predictions, the fleet operator initiates multiple communication(s) 121 with different MCP(s) (each associated with a different truck driver), the analytics component 224 may maintain such number of communications for each driver. Accordingly, by summing the one or more of the above calculations (e.g., EgoMetricScore+InteractantScore+HoRScore+TBRScore+WordCountScore+LoginScore+ConversationScore+WorkLoadScore), the communication (“Comm.”) quality score component 311 may derive a total conversation quality score value that represents a measureable effectiveness (e.g., by assigning a value 1-100, where 100 is extremely effective and 1 is not effective) of the communication.

In some aspects, the conversation quality score value may be outputted to manager ranking component 315 that may utilize the total conversation quality score to rank the one or more managers in order (e.g., with a value of the ranking ascending or descending based on a value of the total conversation quality score) based on the total conversation quality value. In one or more examples, the manager ranking component 315 may associate a manager ID 314 with the rank 318. Similarly, the manager ranking component 315 may be used to quantify the effectiveness of the communication 121 for corrective measures taken for safety (e.g., if the advanced warning system identifies flaws in driving behavior that may result in preventable accident) or retention of the drivers.

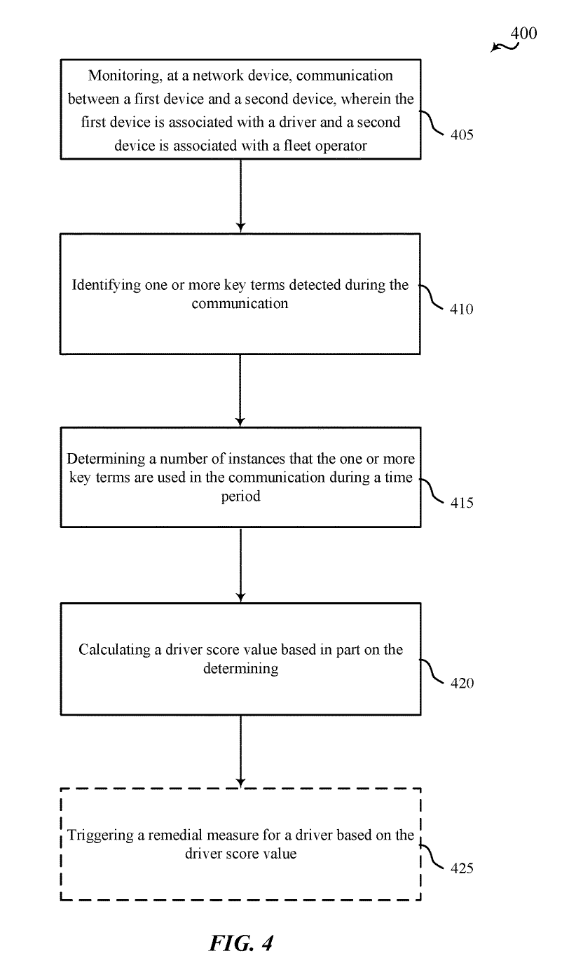

FIG. 4 illustrates one example of a method 400 of implementing communication mining capability in accordance with various aspects of the present disclosure. In some aspects, the method 400 may be implemented by the NMC 112 and/or data center 212 described with reference to FIGS. 1-3.

At block 405, the method 400 may include monitoring, at a network device, communication between a first device and a second device, wherein the first device may be associated with a driver and a second device may be associated with a fleet operator. In some examples, the first device may be the MCP 106 and the second device may be the terminal device 225 located remotely from the MCP 106. In some aspects, the communication may be either text or voice communication including communication data 105. Aspects of block 405 may be performed by communication monitoring component 220 described with reference to FIG. 2.

At block 410, the method 400 may include identifying one or more key terms detected during the communication. In some examples, identifying the key terms during the communication may include referencing the database 214 (see FIG. 2) for one or more key terms that may signify characteristics for determining quality conversation. Aspects of block 410 may also be performed by communication monitoring component 220 described with reference to FIG. 2

At block 415, the method 400 may include determining a number of instances that the one or more key terms are used in the communication during a time period. In some examples, determining the number of instances that the one or more key terms are used further comprises determining whether the number of instances is greater than fleet average (e.g., accumulation of the averages for a plurality of drivers). Additionally or alternatively, determining the number of instances that the one or more key terms are used further comprises determining whether the number of instances is greater than the driver's own baseline average. In some aspects, the baseline average of the driver may be established by averaging the number of times that the driver, in the past, has used one or more key terms (e.g., 2 times per week for past 10 weeks). Therefore, aspects of the present disclosure correlate the frequency of terms against not only other drivers, but may also compare against the driver's own baseline average. Aspects of block 415 may be performed by analytics component 224.

At block 420, the method 400 may include calculating a driver score value based in part on the determining a number of instances that the one or more key terms are used in the communication during a time period. In some examples, calculating the driver score value based in part on the determining a number of instances that the one or more key terms are used in the communication during a time period comprises identifying one or more drivers that may be at risk for an adverse event (e.g., quitting or being susceptible to a preventable accident). Aspects of block 420 may be performed by analytics component 224.

At block 425, the method 400 may include triggering a remedial measure for a driver based on the driver score value. In some aspects, remedial measure(s) may include adjusting the driving schedule or driving routes for each driver (e.g., such that the driver is home more often), for example, if the analytics system 108 identifies work factors that may be important to each driver. In other examples, the remedial measure(s) may include initiating further communications with the driver to ensure a change in driving behavior (e.g., requesting the driver to maintain a safe distance from other vehicles or driving during the daytime) if the original communication is rendered ineffective.

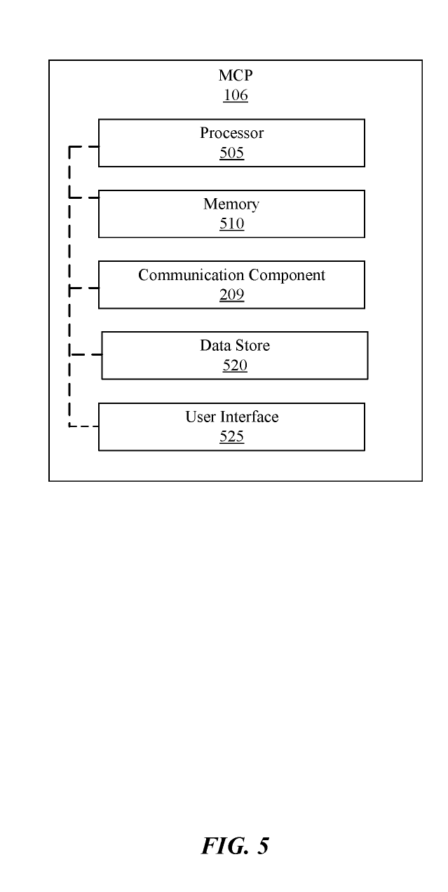

Referring to FIG. 5, in an example that should not be construed as limiting, MCP 106 may include additional components that operate in conjunction with vehicle management component(s) 207, which may be implemented in specially programmed computer readable instructions or code, firmware, hardware, or some combination thereof.

In an aspect, features described herein with respect to the functions of communication component 209 may be implemented in or executed using one or any combination of processor 505, memory 510, communications component 209, and data store 520. For example, communication component 209 may be defined or otherwise programmed as one or more processor components of processor 505. Further, for example, communication component 209 may be defined as a computer-readable medium (e.g., a non-transitory computer-readable medium) stored in memory 510 and/or data store 520 and executed by processor 505. Moreover, for example, inputs and outputs relating to operations of communication component 209 may provide a bus between the components of computer device or an interface for communication with external devices or components. Processor 505 can include a single or multiple set of processors or multi-core processors. Moreover, processor 505 can be implemented as an integrated processing system and/or a distributed processing system.

Memory 510 may operate to allow storing and retrieval of data used herein and/or local versions of applications and/or software and/or instructions or code being executed by processor 505, such as to perform the respective functions of communication component 209 described herein. Memory 510 can include any type of memory usable by a computer, such as random access memory (RAM), read only memory (ROM), tapes, magnetic discs, optical discs, volatile memory, non-volatile memory, and any combination thereof.

Communication component 209 is operable to establish and maintain communications with one or more internal components/components or external devices utilizing hardware, software, and services as described herein. Communication component 209 may further carry communications between components on MCP 106, as well as between user and external devices, such as devices located across a communications network and/or devices serially or locally connected to MCP 106. For example, communications component 209 may include one or more buses, and may further include transmit chain components and receive chain components associated with a transmitter and receiver, respectively, or a transceiver, operable for interfacing with external devices.

Additionally, data store 520, which can be any suitable combination of hardware and/or software, which provides for mass storage of information, databases, and programs employed in connection with aspects described herein. For example, data store 520 may be a data repository for applications not currently being executed by processor 505.

MCP 106 may additionally include a user interface component 525 operable to receive inputs from a user, and further operable to generate outputs for presentation to the user. User interface component 525 may include one or more input devices, including but not limited to a keyboard, a number pad, a mouse, a touch-sensitive display, a navigation key, a function key, a microphone, a voice recognition component, any other mechanism capable of receiving an input from a user, or any combination thereof. Further, user interface component 525 may include one or more output devices, including but not limited to a display, a speaker, a haptic feedback mechanism, a printer, any other mechanism capable of presenting an output to a user, or any combination thereof.

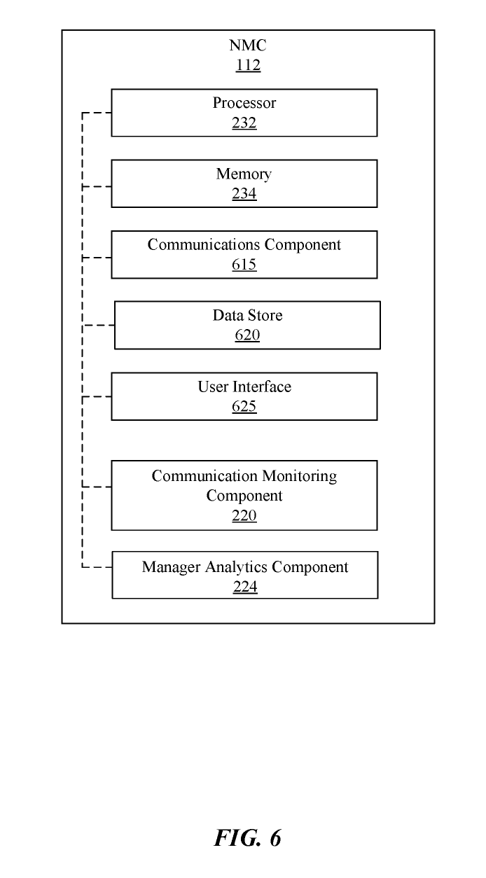

Referring to FIG. 6, in an example that should not be construed as limiting, NMC 112 may include additional components for implementing advanced warning system and in particular for operating in conjunction with communication monitoring component 220 and manager analytics component 224, which may be implemented in specially programmed computer readable instructions or code, firmware, hardware, or some combination thereof.

In an aspect, the features of communication monitoring component 220 and drive analytics component 224 described herein may be implemented in or executed using one or any combination of processor 232, memory 234, communications component 615, and data store 620. For example, communication monitoring component 220 and analytics component 224 may be defined or otherwise programmed as one or more processor components of processor 232. Further, for example, communication monitoring component 220 and drive analytics component 224 may be defined as a computer-readable medium (e.g., a non-transitory computer-readable medium) stored in memory 234 and/or data store 610 and executed by processor 232. Moreover, for example, inputs and outputs relating to operations of communication monitoring component 220 and analytics component 224 may be provided or supported by communications component 615, which may provide a bus between the components/components of NMC 112 or an interface for communication with external devices or components/components.

Processor 232 can include a single or multiple set of processors or multi-core processors. Moreover, processor 232 can be implemented as an integrated processing system and/or a distributed processing system.

Memory 234 may be operable for storing and retrieving data used herein and/or local versions of applications and/or software and/or instructions or code being executed by processor 232, such as to perform the respective functions of the respective entities described herein. Memory 234 can include any type of memory usable by a computer, such as random access memory (RAM), read only memory (ROM), tapes, magnetic discs, optical discs, volatile memory, non-volatile memory, and any combination thereof.

Communications component 615 may be operable to establish and maintain communications with one or more internal components/components and/or external devices utilizing hardware, software, and services as described herein. Communications component 615 may carry communications between components on NMC 112, as well as between user and external devices, such as devices located across a communications network and/or devices serially or locally connected to NMC 112. For example, communications component 615 may include one or more buses, and may further include transmit chain components and receive chain components associated with a transmitter and receiver, respectively, or a transceiver, operable for interfacing with external devices.

Additionally, data store 620, which can be any suitable combination of hardware and/or software, which provides for mass storage of information, databases, and programs employed in connection with aspects described herein. For example, data store 620 may be a data repository for applications not currently being executed by processor 232.

NMC 112 may additionally include a user interface component 625 operable to receive inputs from a user, and further operable to generate outputs for presentation to the user. User interface component 625 may include one or more input devices, including but not limited to a keyboard, a number pad, a mouse, a touch-sensitive display, a navigation key, a function key, a microphone, a voice recognition component, any other mechanism capable of receiving an input from a user, or any combination thereof. Further, user interface component 626 may include one or more output devices, including but not limited to a display, a speaker, a haptic feedback mechanism, a printer, any other mechanism capable of presenting an output to a user, or any combination thereof.

In view of the disclosure above, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the figures which may illustrate various process flows.

In the above description, the term “software product” may include files having executable content, such as: object code, scripts, byte code, markup language files, and patches. In addition, a “software product” referred to herein, may also include files that are not executable in nature, such as documents that may need to be opened or other data files that need to be accessed.

The term “software update” may also include files having executable content, such as: object code, scripts, byte code, markup language files, and patches. In addition, “software update” referred to herein, may also include files that are not executable in nature, such as documents that may need to be opened or other data files that need to be accessed.

As used in this description, the terms “component,” “database,” “component,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and blue-ray disc where disks usually reproduce data magnetically, while discs reproduce data optically with lasers. Combinations of the above should also be included within the scope of computer-readable media.

Although selected aspects have been illustrated and described in detail, it will be understood that various substitutions and alterations may be made therein without departing from the spirit and scope of the present invention, as defined by the following claims.

What is claimed is:

1. A method for wireless communication, comprising:
monitoring, at a network device, communication between a first device and a second device, wherein the first device is associated with a driver and a second device is associated with a fleet operator;
identifying one or more key terms detected during the communication;
determining a number of instances that the one or more key terms are used in the communication during a time period; and
calculating a driver score value based in part on the determining.

2. The method of claim 1, further comprising triggering a remedial measure for a driver based on the driver score value.

3. The method of claim 1, further comprises:
calculating a conversation quality score for each communication during the time period; and
calculating the manager score value based on the conversation quality score.

4. The method of claim 3, wherein the calculating the conversation quality score comprises:
identifying an accident predicted value prior to establishing the communication;
identifying an actual accident score following the communication; and
determining a difference between the accident predicted value and the actual accident score.

5. The method of claim 4, further comprising:
increasing the conversation quality score if the accident predicted value is greater than the actual accident score; and
decreasing the conversation quality score if the accident predicted value is less than the actual accident score.

6. The method of claim 3, wherein the calculating the conversation quality score comprises:
identifying a retention prediction value prior to establishing the communication;
identifying an actual retention value following the communication; and
determining a difference between the retention prediction value and the actual retention value.

7. The method of claim 6, further comprising:
increasing the conversation quality score if the retention prediction value is greater than the actual retention value; and
decreasing the conversation quality score if the retention prediction value is less than the actual retention value.

8. The method of claim 1, further comprising ranking one or more manager in accordance with the manager score value.

9. An apparatus for wireless communication, comprising:
a processor; and
a memory, wherein the memory includes instructions executable by the processor to:
monitor, at a network device, communication between a first device and a second device, wherein the first device is associated with a driver and a second device is associated with a fleet operator;
identify one or more key terms detected during the communication;
determine a number of instances that the one or more key terms are used in the communication during a time period; and
calculate a driver score value based in part on the determining.

10. The apparatus of claim 9, wherein the instructions are further executable to trigger a remedial measure for a driver based on the driver score value.

11. The apparatus of claim 9, wherein the instructions are further executable to:
calculate a conversation quality score for each communication during the time period; and
calculate the manager score value based on the conversation quality score.

12. The apparatus of claim 11, wherein the instructions are further executable to:
identify an accident predicted value prior to establishing the communication;
identify an actual accident score following the communication; and
determine a difference between the accident predicted value and the actual accident score.

13. The apparatus of claim 11, wherein the instructions are further executable to:
increase the conversation quality score if the accident predicted value is greater than the actual accident score; and
decrease the conversation quality score if the accident predicted value is less than the actual accident score.

14. The apparatus of claim 11, wherein the instructions are further executable to:
identify a retention prediction value prior to establishing the communication;
identify an actual retention value following the communication; and
determine a difference between the retention prediction value and the actual retention value.

15. The apparatus of claim 14, wherein the instructions are further executable to:
increase the conversation quality score if the retention prediction value is greater than the actual retention value; and
decrease the conversation quality score if the retention prediction value is less than the actual retention value.

16. The apparatus of claim 9, wherein the instructions are further executable to rank one or more manager in accordance with the manager score value.

17. A computer-readable medium for wireless communication, comprising code for:
monitoring, at a network device, communication between a first device and a second device, wherein the first device is associated with a driver and a second device is associated with a fleet operator;
identifying one or more key terms detected during the communication;
determining a number of instances that the one or more key terms are used in the communication during a time period; and
calculating a driver score value based in part on the determining.

18. The computer-readable medium of claim 17, wherein the code further comprises triggering a remedial measure for a driver based on the driver score value.

19. The computer-readable medium of claim 17, wherein the code further comprises:
calculating a conversation quality score for each communication during the time period; and
calculating the manager score value based on the conversation quality score.

20. The computer-readable medium of claim 19, wherein calculating the conversation quality score further comprises code for:
identifying an accident predicted value prior to establishing the communication;
identifying an actual accident score following the communication; and
determining a difference between the accident predicted value and the actual accident score.
